(19) United States
(12) Patent Application Publication
(10) Pub. No.: US 2017/0252943 A1
(43) Pub. Date: Sep. 7, 2017

(54) A LARGE-SIZE DESERT SALIX WOOD BUILDING MATERIAL AND MANUFACTURING METHOD THEREOF

(71) Applicant: Maolin LI, Tianjin (CN)

(72) Inventor: Maolin LI, Tianjin (CN)

(21) Appl. No.: 15/503,853

(22) PCT Filed: Sep. 9, 2015
(86) PCT No.: PCT/CN2015/089222

§ 371 Date: Feb. 14, 2017

(30) Foreign Application Priority Data
Sep. 15, 2014 (CN) 201410468541.7

(51) Int. Cl. B27N 3/04; B27K 5/02

(52) U.S. Cl. CPC B27N 3/04; B27K 5/02

(57) ABSTRACT

The present invention relates to a large-size desert salix wood building material and manufacturing method thereof. The manufacturing method comprises the following steps: desert salix growing in a same period is used as raw materials; desert salix branches are peeled and degreased by methods of heating stewing and water pressure blasting; gum-dipped desert salix strand silks are dried, dyed and assembled synchronously by one time, and then are pressed, glued and cured, and thereby a large-size desert salix wood building material of a size of (12000-30000 mm)×400 mm×300 mm is obtained. The present invention has the following beneficial effects: desert salix planted and cultivated in a same period in a desert is adopted as raw material, and is processed to produce a large-size desert salix wood building material, which has accordant material properties, excellent mechanical performance and controllable quality, providing an engineering structure material which is ecological green, energy saving and environmentally protective for building industry, so that a natural forest resource is facilitated to be saved, and the consumption of a fossil resource is reduced; specifically, a sustainable industrial method for preventing and controlling desertification is provided, so that a positive effect on repair and protection of human ecological environment is achieved.

### TECHNICAL FIELD

The present invention relates to the field of ecological green building materials, in particular to a large-size desert salix (Salix cheilophila, Salix psammophila or Salix brachycarpa) wood building material and manufacturing method thereof.

### BACKGROUND ART

Currently, in the production practice of the patent “method for manufacturing dyed desert salix hard wood” of the present invention, it is found that there are problems existing as follows: (1) the raw materials of purchased desert salix have different growth periods, and the size and material properties thereof are different; (2) the skin of the desert salix is peeled incompletely and a small amount of skins are mixed into the wood battens; (3) when the dyed desert salix hard wood is used as a beam column building material, the size thereof cannot meet the requirements for use; (3) the chemical method for dyeing the desert salix produces environmental pollution; and (4) the assembly method is slow and the product thereof is not sufficiently uniform.

### SUMMARY

The purpose of the present invention is to provide a large-size desert salix wood building material and manufacturing method thereof to overcome the above shortcomings.

The technical solution of the present invention is achieved as follows: a large-size desert salix wood building material, characterized in that: it is manufactured as a (12000-30000 mm)×400 mm×300 mm large-size desert salix wood building material using desert salix growing in the same period as raw materials; and the main technical indexes thereof are: ≧density 0.75 g/cm³, bending strength 100 Mpa, tensile strength 200 Mpa, and vertical compressive strength 100 Mpa.

A method for manufacturing a large-size desert salix wood building material, characterized in that: desert salix growing in the same period is used as raw materials; desert salix branches are peeled and degreased by methods of heating stewing and water pressure blasting; gum-dipped desert salix strand silks are dried, dyed and assembled synchronously by one time; then pressing, gluing and curing are carried out, and thereby a large-size desert salix wood building material is obtained. The specific implementation steps are as follows:

(1) Planting, cultivating, harvesting and use of raw materials: desert salix is a desert shrub, and it is planted in the desert by cuttage method with a small distance between the plants and a row spacing of 6-8 meters; low plants such as alfalfa and others are planted between the rows of desert salix to conserve water to promote the growth of desert salix, and the two plants are harvested flat stubble simultaneously in the autumn or winter season once each year; after desert salix twigs located at a position higher than 2.5 meters are removed, desert salix branches having a length of 2.5 meters are used as raw materials;

(2) Peeling and degreasing of desert salix branches: the desert salix branches are peeled and degreased by methods of heating stewing and water pressure blasting; the desert salix branches are placed into a tooling basket and sent into a vacuum tank equipped with a heating device; after the door of the tank is closed and then the tank is filled with water, the heating device is started to work and heats the water in the tank to a temperature of 100° C., the heating is continued and the desert salix branches are stewed for 60-90 minutes, so that the water absorption of the desert salix branches reaches an over-saturation state of greater than or equal to 130%; then the pressure pump of the vacuum tank is started to work to increase the pressure to 0.4-0.5 MPa, and at this time the skins of the desert salix branches are fractured and removed, and the grease substances of the desert salix branches are dissolved and removed simultaneously, which help to improve the bonding strength of the desert salix wood;

(3) Shredding of the desert salix branches: the peeled and degreased wet desert salix branches are continuously processed in a rolling shredding machine; the desert salix branches are placed into a water tank; the desert salix branches completely peeled are taken out of the water tank and sent to the rolling shredding machine, rolled to be a flat shape by a roller and shredded into desert salix strand silks simultaneously by a rolling cutter of the rolling shredding machine;

(4) Air drying naturally: the desert salix strand silks are bundled, and air dried naturally by standing on a drying rack with a distance of 200 mm above the ground; the desert salix strand silks are stored for later use when the average water content of the dried desert salix strand silks is less than or equal to 15%;

(5) Gum-dipping of the desert salix strand silks: the desert salix strand silks having an average water content of 15% or less are soaked into a water soluble phenolic resin having a solid content of 20-25%; the process of gum-dipping is completed when the liquid absorption amount of these desert salix strand silks is 125-130%;

(6) Drying, dyeing and assembling of the gum-dipped desert salix strand silks: a mesh belt dryer, which is commonly used in the artificial board industry, is used and further transformed with an ultraviolet lamp installed above the mesh belt of the mesh belt dryer and a sliding plate tilting 35° installed at the outlet of the mesh belt dryer and a blank box carrying out horizontal reciprocating motion arranged under the sliding plate; after being sent into the mesh belt dryer, the gum-dipped desert salix strand silks are dried continuously at 70-75° C., and at the same time, phenolic resins in the desert salix strand silks are subjected to chemical reaction under the irradiation of ultraviolet light, as a result of which the desert salix strand silks turn to be brownish red; these dried and discolored desert salix strand silks having an average water content of 15% or less fall continuously into the blank box moving to and fro horizontally through the sliding plate at the outlet, and lap joint each other evenly and thus form a blank with required specification;

(7) Pressing, gluing and heat treatment: a vertical and horizontal integrated combined-type cold press machine is used to press; the blank formed by lapping joint the desert salix strand silks is pressed into an iron mould box using a working pressure of 700-900 kg/cm², then the iron mould box and the blank therein are pushed out of the press machine onto a transfer roller table and sent directly into a high temperature kiln with a transfer roller by the transfer roller table; the transfer roller continuously transfers the iron mould box and the blank therein forward at a speed of 0.1 m/min; the blank formed of desert salix strand silks in the iron mould box are glued and cured to a monolithic material after being heated continuously for 9-10 hours in the high temperature kiln at a temperature of 140-150° C., and at the same time, the pressing stress within the material is relieved after a long period of heat treatment; and (8) Demolding and processing: after being glued, cured and heated in the high temperature kiln, the desert salix wood materials are taken out of the high temperature kiln, and cooled to a temperature of less than or equal to 35° C. and then demoulded; iron plates of the iron mould box around the materials are removed by a demolding machine; then the materials are sent to a trim saw and are cut by a saw with a fixed length, and thereby the required large-size desert salix wood material is obtained.

The present invention has the following beneficial effects: desert salix planted and cultivated in a same period in a desert is adopted as raw materials, which is processed to produce a large-size desert salix wood material, which has accordant material properties and controllable quality, providing an engineering structure material which is ecological green, energy saving and environmentally protective for building industry, so that a natural forest resource is facilitated to be saved, and the consumption of a fossil resource is reduced; specifically, a sustainable industrial method for preventing and controlling desertification is provided, so that a positive effect on repair and protection of human ecological environment is achieved.

### EMBODIMENTS

In the following, the specific embodiments provided in accordance with the present invention will be described in detail with reference to a preferred example.

Example: a large-size desert salix wood building material, which is manufactured as a 20000 mm×400 mm×300 mm large-size desert salix wood building material using desert salix growing in a same period as raw materials. The main technical indexes thereof are: density 0.85 g/cm³, bending strength 100 Mpa, tensile strength 200 Mpa, and vertical compressive strength 100 Mpa.

A method for manufacturing a large-size desert salix wood building material as follows: desert salix growing in the same period is used as raw materials; desert salix branches are peeled and degreased by methods of heating stewing and water pressure blasting; gum-dipped desert salix strand silks are dried, dyed and assembled synchronously by one time; then pressing, gluing and curing are carried out, and thereby a large-size desert salix wood building material is obtained. The specific implementation steps are as follows:

(1) Planting, cultivating, harvesting and use of raw materials: desert salix is a desert shrub, and it is planted in a desert by cuttage method with a small distance between the plants and a row spacing of 6-8 meters; low plants such as alfalfa and others are planted between the rows of desert salix to conserve water to promote the growth of desert salix, and the two plants are harvested flat stubble simultaneously in the autumn or winter season once each year. After desert salix twigs located at a position higher than 2.5 meters are removed, desert salix branches having a length of 2.5 meters are used as raw materials;

(2) Peeling and degreasing of the desert salix branches: the desert salix branches are peeled and degreased by methods of heating stewing and water pressure blasting; the desert salix branches having a length of 2.5 meters are placed into a tooling basket and sent into a vacuum tank equipped with a heating device; after the door of the tank is closed and then the tank is filled with water, the heating device is started to work and heats the water in the tank to a temperature of 100° C., the heating is continued and the desert salix branches are stewed for 80 minutes, so that the water absorption of desert salix branches reaches an over-saturation state of 140%; then the pressure pump of the vacuum tank is started to work to increase the pressure to 0.45 MPa, and at this time the skins of the desert salix branches are fractured and removed, and the grease substances of the desert salix branches are dissolved and removed simultaneously, which help to improve the bonding strength of the desert salix wood;

(3) Shredding of desert salix branches: the peeled and degreased wet desert salix branches having a length of 2.5 meters are placed into a water tank; the desert salix branches completely peeled are taken out of the water tank and sent to a rolling shredding machine, rolled to be a flat shape by a roller and shredded into desert salix strand silks simultaneously by a rolling cutter of the rolling shredding machine;

(4) Air drying naturally: the desert salix strand silks are bundled, and air dried naturally by standing on a drying rack with a distance of 200 mm above the ground; the desert salix strand silks are stored for later use when the average water content of the dried desert salix strand silks is less than or equal to 15%;

(5) Gum-dipping of the desert salix strand silks: the desert salix strand silks having an average water content of 12% are soaked into a water soluble phenolic resin having a solid content of 25%; the process of gum-dipping is completed when the liquid absorption amount of the desert salix strand silks is 125%;

(6) Drying, dyeing and assembling of the gum-dipped desert salix strand silks: a mesh belt dryer, which is commonly used in the artificial board industry, is used and further transformed with an ultraviolet lamp installed above the mesh belt of the mesh belt dryer and a sliding plate tilting 35° installed at the outlet of the mesh belt dryer and a blank box of a size of 21000 mm×600 mm×400 mm carrying out horizontal reciprocating motion arranged under the sliding plate; after being sent into the mesh belt dryer, the gum-dipped desert salix strand silks are dried continuously at 70-75° C., and at the same time, phenolic resins in the desert salix strand silks are subjected to chemical reaction under the irradiation of ultraviolet light, as a result of which the desert salix strand silks turn to be brownish red; these dried and discolored desert salix strand silks having an average water content of 15% fall continuously into the blank box moving to and fro horizontally through the sliding plate at the outlet, and lap joint each other evenly and thus form a required blank having a size of 21000 mm×600 mm×350 mm;

(7) Pressing, gluing and heat treatment: a vertical and horizontal integrated combined-type cold press machine is used to press; the blank box having a size of 20200 mm×600 mm×400 mm is removed on a feeding platform outside the combined-type cold press machine, and the blank having a weight of 22182 kg and a size of 20200 mm×600 mm×350 mm are sent into the press machine by a reciprocating plate of the combined-type cold press machine and the blank formed by lapping joint the desert salix strand silks is pressed into an iron mould box using a working pressure of 800 kg/cm²; then the iron mould box and the blank therein are pushed out of the press machine onto a transfer roller table and sent directly into a high temperature kiln with a transfer roller by the transfer roller table; the transfer roller continuously transfers the iron mould box and the blank therein forward at a speed of 0.1 m/min; the blank formed of the desert salix strand silks in the iron mould box are glued and cured to a monolithic material after being heated continuously for 10 hours in the high temperature kiln at a temperature of 145° C., and at the same time, the pressing stress within the material is relieved after a long period of heat treatment; and

(8) Demolding and processing: after being glued, cured and heated in the high temperature kiln, the desert salix wood blank having a size of 20200 mm×400 mm×300 mm is taken out of the high temperature kiln, and cooled to a temperature of less than or equal to 35° C. and then demoulded; iron plates of the mould around the materials are removed by a demolding machine; then the materials are sent to a trim saw and are cut by a saw with a fixed length, and thereby a large-size desert salix wood building material having a size of 20000 mm×400 mm×300 mm is obtained.

The above detailed description for the large-size desert salix wood building material and manufacturing method thereof with reference to the example is intended to be illustrative rather than limiting. Examples of producing desert salix wood building materials with various specifications from desert salix in accordance with the defined scope of the present invention can be listed. Therefore, any change and modification without deviating from the general concept of the present invention will fall into the protection scope of the present invention.

1. A desert salix wood building material comprising desert salix and exhibiting the following properties, including: density of at least 0.75 g/cm³, bending strength of at least 100 Mpa, tensile strength of at least 200 Mpa, and vertical compressive strength of at least 100 Mpa.

2. A method for manufacturing a desert salix wood building material comprising:
(1) Planting, cultivating, and harvesting;
(2) Peeling and degreasing of the desert salix branches heating stewing and water pressure blasting;
(3) Shredding of the desert salix branches to form desert salix strand silks;
(4) Air drying the desert salix strand silks;
(5) Gum dipping the desert salix strand silks;
(6) Drying, dyeing and assembling the gum dipped desert salix strand silks;
(7) Pressing, gluing and heat treating; and
(8) Demolding and processing the desert salix strand silks wood to obtain the desert salix wood building material.
